(19) United States
(12) Patent Application Publication
(10) Pub. No.: US 2026/0074567 A1
(43) Pub. Date: Mar. 12, 2026

(54) WIRELESS POWER SUPPLY SYSTEM AND POWER RECEPTION DEVICE

(71) Applicant: Murata Manufacturing Co., Ltd., Kyoto-fu (JP)

(72) Inventors: Takahiro NAGAI, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/394,283

(22) Filed: Nov. 19, 2025

Related U.S. Application Data
(63) Continuation of application No. PCT/JP2024/014337, filed on Apr. 9, 2024.

(30) Foreign Application Priority Data
May 24, 2023 (JP) 2023-085138

(51) Int. Cl. H02J 50/12; H02J 7/00; H02J 50/40; H02J 50/90

(52) U.S. Cl. CPC H02J 50/12; H02J 7/80; H02J 7/933; H02J 50/40; H02J 50/90

(57) ABSTRACT

A power reception device includes a power reception rectification circuit that converts a high-frequency power received by a power reception resonance circuit into a DC power on the power reception side; a battery charged by the DC power on the power reception side; a power reception rectification control circuit that controls the power reception rectification circuit; and a power reception state detection circuit in which physical energy changes according to the power reception state of the power reception rectification circuit. A power transmission device executes an intermittent power transmission operation at a predetermined period. The power reception rectification control circuit determines, based on the measurement of the physical energy of the power reception state detection circuit, whether the power reception device is in a state in which it is continuously arranged, or a state in which it is rearranged, with respect to the power transmission device.

### CROSS-REFERENCE TO RELATED APPLICATIONS

This application claims benefit of priority to International Patent Application No. PCT/JP2024/014337, filed Apr. 9, 2024, and to Japanese Patent Application No. 2023-085138, filed May 24, 2023, the entire contents of each are incorporated herein by reference.

### BACKGROUND

### Technical Field

The present disclosure relates to a power reception device having a battery, and a wireless power supply system including the power reception device.

### Background Art

A wireless power supply system described in International Publication No. 2020/183819 controls charging of a battery of a power reception device and stopping of power transmission of a power transmission device without using other communication than power supply between the power transmission device and the power reception device.

The power reception device generates a power transmission stop signal based on whether the voltage of the battery is equal to or higher than a threshold value. Further, the power reception device generates a power transmission stop signal based on a high-frequency power intermittently supplied from the power transmission device.

Thus, the wireless power supply system described in International Publication No. 2020/183819 performs charging, distinguishing between a state in which the power reception device is still arranged with respect to the power transmission device after charging is completed and a state in which the power reception device has been newly arranged with respect to the power transmission device.

### SUMMARY

However, since the power reception device generates the power transmission stop signal by using a change in a magnetic field excited by the power transmission device, there is a possibility of malfunction when a disturbance magnetic field occurs. Further, the power reception device cannot distinguish, by the function thereof only, between a state in which the power reception device is still arranged with respect to the power transmission device and a state in which the power reception device has been newly arranged with respect to the power transmission device, without executing complicated control.

Accordingly, the present disclosure provides a power reception device and a wireless power supply system that distinguish between a state in which the power reception device is still arranged with respect to a power transmission device and a state in which the power reception device has been newly arranged with respect to the power transmission device, without executing complicated control, to thereby suppress overcharging and overdischarging of the battery to prolong the life of the battery so as to prolong the life of the device, and achieve high power efficiency and excellent reliability.

The present disclosure relates to a wireless power supply system that includes a power transmission device including a power transmission resonance circuit having a power transmission coil; and a power reception device including a power reception resonance circuit having a power reception coil. The power reception device is arranged with respect to the power transmission device for charging, so that the power transmission resonance circuit and the power reception resonance circuit form electromagnetic field resonance coupling to perform wireless power supply.

The power transmission device includes a power transmission switching circuit that converts a DC power supplied from a DC power source on a power transmission side into a high-frequency power to be transmitted from the power transmission resonance circuit; and a power transmission switching control circuit that controls the power transmission switching circuit.

The power reception device includes a power reception rectification circuit that converts the high-frequency power received by the power reception resonance circuit into a DC power; a battery to be charged by the DC power on a power reception side; a power reception rectification control circuit that controls the power reception rectification circuit; and a power reception state detection circuit that detects an amount of physical energy that changes according to a power reception state.

The power transmission device performs an intermittent power transmission operation. The power reception rectification control circuit determines, based on the amount of physical energy detected by the power reception state detection circuit, whether the power reception device is in a state in which the power reception device is still continuously arranged with respect to the power transmission device or in a state in which the power reception device has been newly rearranged with respect to the power transmission device.

In such a configuration, the amount of physical energy (electric energy, thermal energy or the like) of the power reception state detection circuit changes according to a time-dependent arrangement state of the power reception device with respect to the power transmission device. By measuring the amount (variation) of physical energy, it is possible to determine the time-dependent arrangement state of the power reception device with respect to the power transmission device, specifically, to determine whether the power reception device is in a state in which the power reception device is still continuously arranged with respect to the power transmission device or in a state in which the power reception device has been newly rearranged with respect to the power transmission device, without executing complicated control.

According to the present disclosure, it is possible to provide a power reception device and a wireless power supply system that distinguish between a state in which the power reception device is still arranged with respect to a power transmission device and a state in which the power reception device has been newly arranged with respect to the power transmission device, without executing complicated control, to thereby suppress overcharging and overdischarging of the battery to prolong the life of the battery so as to prolong the life of the device, and achieve high power efficiency and excellent reliability.

### BRIEF DESCRIPTION OF THE DRAWINGS

FIG. 1 is a diagram showing an example of a configuration of a power reception device of a wireless power supply system according to a first embodiment of the present disclosure;

FIG. 2 is a diagram showing an example of a configuration of a power transmission device of the wireless power supply system according to the first embodiment of the present disclosure;

FIG. 3A is a diagram showing a charging current to a capacitor, and FIG. 3B is a diagram showing a discharging current of the capacitor;

FIG. 4 is a flowchart showing an example of arrangement state determination processing according to the first embodiment;

FIG. 5 is a graph showing the time variation of a capacitor voltage VCAP during discharge;

FIG. 6 is a timing chart showing an example of transmission power, control circuit power, capacitor charging power, capacitor voltage, and determination processing in a continuous arrangement state of the power reception device according to the first embodiment;

FIG. 7 is a timing chart showing an example of transmission power, control circuit power, capacitor charging power, capacitor voltage, and determination processing in a rearrangement state of the power reception device according to the first embodiment;

FIG. 8 is a diagram showing an example of a configuration of a power reception device of a wireless power supply system according to a second embodiment of the present disclosure;

FIG. 9 is a flowchart showing an example of determination processing of a control circuit according to the second embodiment;

FIG. 10 is a timing chart showing the transition of a period from charging of a battery of the power reception device to intermittent power transmission in a continuous arrangement;

FIG. 11 is a timing chart showing a period from a state in which charging is not performed to a state in which charging is resumed while the power reception device is continuously arranged;

FIG. 12 is a diagram showing an example of a configuration of a power reception device of a wireless power supply system according to a third embodiment of the present disclosure;

FIG. 13 is a diagram showing an example of a configuration of a power reception device of a wireless power supply system according to a fourth embodiment of the present disclosure;

FIG. 14 is a timing chart showing an example of transmission power, control circuit power, capacitor charging power, capacitor voltage, and determination processing in a continuous arrangement state of the power reception device according to the fourth embodiment;

FIG. 15 is a timing chart showing an example of transmission power, control circuit power, capacitor charging power, capacitor voltage, and determination processing in a rearrangement state of the power reception device according to the fourth embodiment;

FIG. 16 is a diagram showing an example of a configuration of a power reception device of a wireless power supply system according to a fifth embodiment of the present disclosure;

FIG. 17 is a timing chart showing an example of transmission power, control circuit power, heating operation, temperature detection voltage, and determination processing in a continuous arrangement state of the power reception device according to the fifth embodiment;

FIG. 18 is a timing chart showing an example of transmission power, control circuit power, heating operation, temperature detection voltage, and determination processing in a rearrangement state of the power reception device according to the fifth embodiment; and

FIG. 19 is a diagram partially showing an example of a conceptual configuration of a wireless power supply system according to a sixth embodiment of the present disclosure.

### DETAILED DESCRIPTION

### First Embodiment

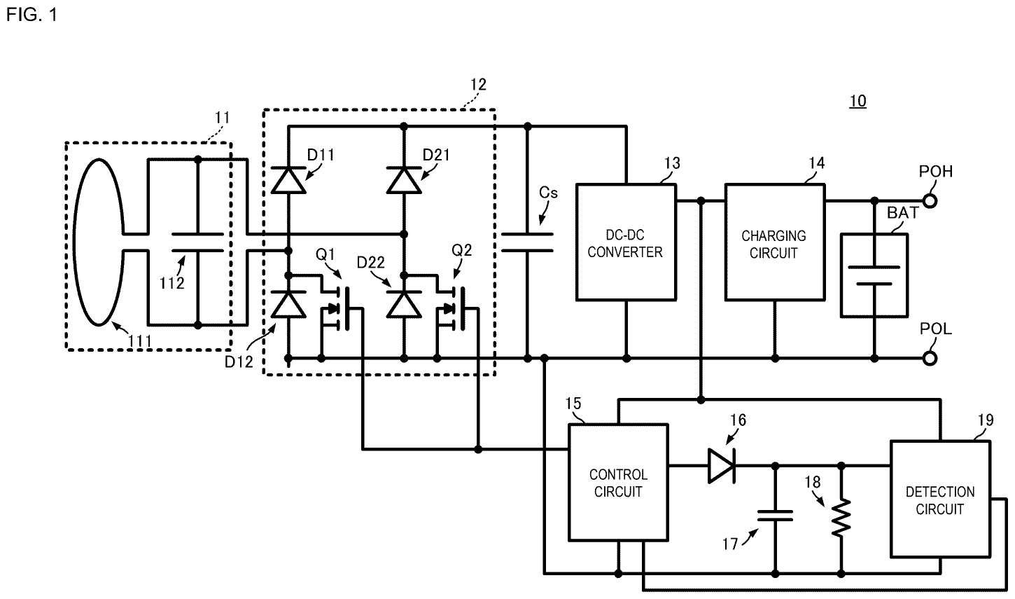

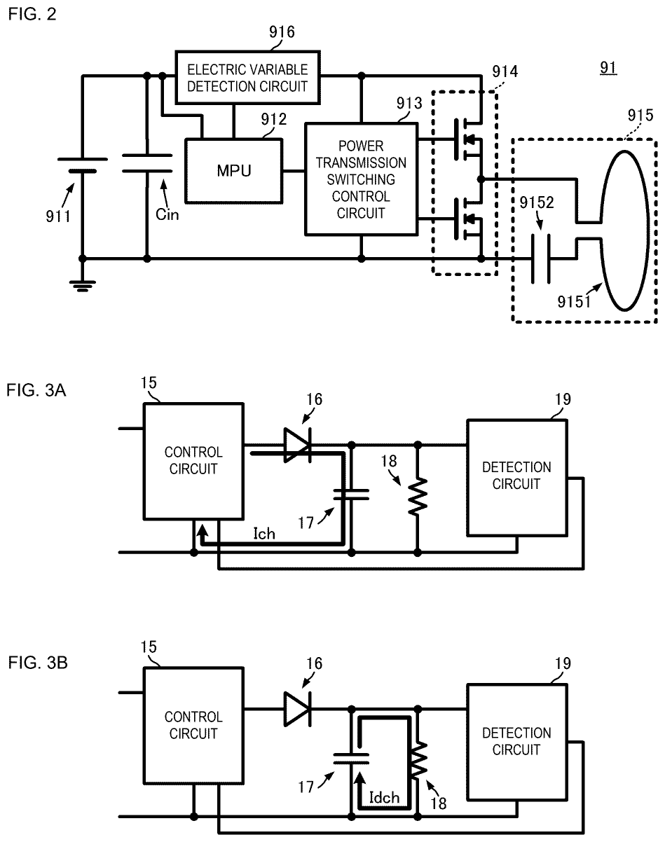

A wireless power supply system according to a first embodiment of the present disclosure will be described with reference to the accompanying drawings. FIG. 1 is a diagram showing an example of a configuration of a power reception device of the wireless power supply system according to the first embodiment of the present disclosure. FIG. 2 is a diagram showing an example of a configuration of a power transmission device of the wireless power supply system according to the first embodiment of the present disclosure.

### (Configuration of Power Reception Device 10)

As shown in FIG. 1, a power reception device 10 includes a power reception resonance circuit 11, a power reception rectification circuit 12, a smoothing capacitor Cs, a DC-DC converter 13, a charging circuit 14, a control circuit 15, a diode 16, a capacitor 17, a resistor 18, a detection circuit 19, a battery BAT, a Hi-side output terminal POH, and a Low-side output terminal POL.

The power reception resonance circuit 11 includes a power reception coil 111 and a resonance capacitor 112. The resonance capacitor 112 and the power reception coil 111 are connected in parallel. Thus, the power reception resonance circuit 11 constitutes a parallel resonance circuit of the power reception coil 111 and the resonance capacitor 112. The resonant frequency of the power reception resonance circuit 11 is substantially the same as the frequency of an external alternating magnetic field to which the power reception coil 111 is coupled, or in other words, is substantially the same as the switching frequency of a power transmission device 91.

The power reception rectification circuit 12 includes a diode D11, a diode D12, a diode D21, and a diode D22, and constitutes a full-wave rectification circuit. The diode D11 and the diode D12 are connected in series, and the diode D12 is connected to a reference potential. The diode D21 and the diode D22 are connected in series, and the diode D22 is connected to the reference potential. The node of the diode D11 and the diode D12 is connected to one output terminal of the power reception resonance circuit 11, and the node of the diode D21 and the diode D22 is connected to the other output terminal of the power reception resonance circuit 11. The node of the diode D11 and the diode D21 is connected to the Hi-side output terminal of the power reception rectification circuit 12, and the node of the diode D12 and the diode D22 is connected to the Low-side output terminal of the power reception rectification circuit 12.

A switching element Q1 is connected in parallel to the diode D12, and a switching element Q2 is connected in parallel to the diode D22. The switching element Q1 and the switching element Q2 are elements for power reception rectification control.

The diode D11, the diode D12, the diode D21, the diode D22, the switching element Q1, and the switching element Q2 constitute a power reception resonance modulation circuit.

The smoothing capacitor Cs is connected between a Hi-side output terminal and a Low-side output terminal of the power reception rectification circuit 12.

The output terminal of the power reception rectification circuit 12 is connected to the input terminal of the DC-DC converter 13. The output terminal of the DC-DC converter 13 is connected to the input terminal of the charging circuit 14.

The battery BAT is connected between a Hi-side output terminal and a Low-side output terminal of the charging circuit 14. The battery BAT is a rechargeable battery possible to be charged and discharged.

The Hi-side output terminal of the charging circuit 14 is connected to the Hi-side output terminal POH of the power reception device 10. The Low-side output terminal of the charging circuit 14 is connected to the Low-side output terminal POL of the power reception device 10.

The control circuit 15 is connected to the output terminal of the DC-DC converter 13. A Hi-side output terminal of the control circuit 15 is connected to the anode of the diode 16, and the cathode of the diode 16 is connected to a detection terminal of the detection circuit 19. A reference potential terminal of the control circuit 15 and a reference potential terminal of the detection circuit 19 are connected to the reference potential. The control circuit 15 is connected to a gate terminal of the switching element Q1 and a gate terminal of the switching element Q2. A circuit consisting of the control circuit 15, the switching element Q1, and the switching element Q2 corresponds to a power reception rectification control circuit.

One terminal of the capacitor 17 is connected to the cathode of the diode 16. The other terminal of the capacitor 17 is connected to the reference potential terminals of the control circuit 15 and the detection circuit 19. The resistor 18 is connected in parallel to the capacitor 17. A capacitor charging circuit for charging the capacitor 17 is constituted by the control circuit 15 and the diode 16. A capacitor discharging circuit is constituted by a closed circuit of the capacitor 17 and the resistor 18. The detection circuit 19 corresponds to a capacitor voltage detection circuit.

A power reception state detection circuit is constituted by including the capacitor 17, the capacitor charging circuit, the capacitor discharging circuit, and the capacitor voltage detection circuit. The storage amount of the capacitor 17 is the amount of electric energy, and corresponds to an amount of physical energy.

### (Configuration of Power Transmission Device 91)

As shown in FIG. 2, the power transmission device 91 includes a DC power source 911, an input capacitor Cin, an MPU 912, a power transmission switching control circuit 913, a power transmission switching circuit 914, a power transmission resonance circuit 915, and an electric variable detection circuit 916.

The input capacitor Cin is connected in parallel with the DC power source 911. The drain terminal of a Hi-side switching element of the power transmission switching circuit 914 is connected, via the electric variable detection circuit 916, to the node of the positive electrode of the DC power source 911 and the input capacitor Cin. The drain terminal of a Low-side switching element of the power transmission switching circuit 914 is connected to the source terminal of the Hi-side switching element of the power transmission switching circuit 914. The drain terminal of the Low-side switching element is connected to the node of the negative electrode of the DC power source 911 and the input capacitor Cin. The node of the negative electrode of the DC power source 911 and the input capacitor Cin is connected to a reference potential.

The output terminal of the electric variable detection circuit 916 is connected to the MPU 912.

The output terminal of the MPU 912 is connected to the power transmission switching control circuit 913. The power transmission switching control circuit 913 is connected to the gate terminal of the Hi-side switching element and the gate terminal of the Low-side switching element of the power transmission switching circuit 914.

The power transmission resonance circuit 915 includes a power transmission coil 9151 and a resonance capacitor 9152.

The resonance capacitor 9152 is connected in series to the power transmission coil 9151. Thus, the power transmission resonance circuit 915 constitutes a series resonance circuit of the power transmission coil 9151 and the resonance capacitor 9152. The resonant frequency of the power transmission resonance circuit 915 is substantially the same as the switching frequency of the power transmission switching circuit 914.

### (Power Supply Control)

When determining that power supply control is to be executed, the MPU 912 outputs a command for executing power supply to the power transmission switching control circuit 913. When a command for executing power supply continuously is inputted, the power transmission switching control circuit 913 controls switching of each switching element of the power transmission switching circuit 914 at a predetermined switching frequency.

The power transmission switching circuit 914 converts the DC voltage supplied from the DC power source 911 into an alternating voltage having a frequency corresponding to the switching frequency, and outputs the alternating voltage to the power transmission resonance circuit 915. That is, the power transmission switching circuit 914 converts the DC power from the DC power source 911 into a high-frequency power, and outputs the high-frequency power to the power transmission resonance circuit 915.

The power transmission resonance circuit 915 resonates at the frequency of the high-frequency power, and the power transmission coil 9151 generates an alternating magnetic field by the high-frequency power.

When the power reception device 10 is arranged for charging with respect to the power transmission device 91, the power reception coil 111 and the power transmission coil 9151 are electromagnetically coupled. The power reception coil 111 generates an AC current corresponding to the coupling degree with the alternating magnetic field, and outputs the AC current to the power reception rectification circuit 12.

At this time, since the resonant frequency of the power reception resonance circuit 11 is the same as the frequency of the alternating magnetic field, i.e., is the same as the resonant frequency of the power transmission resonance circuit 915, the power reception resonance circuit 11 and the power transmission resonance circuit 915 form electromagnetic field resonance coupling. Thus, low-loss wireless power supply from the power transmission device 91 to the power reception device 10 is realized. Note that the frequency of the alternating magnetic field of the wireless power supply is preferably in a 6.78 MHz band or a 13.56 MHz band.

The power reception rectification circuit 12 rectifies the inputted AC current and outputs a rectified current. That is, the power reception rectification circuit 12 converts the high-frequency power received by the power reception resonance circuit 11 into a DC power and outputs the DC power.

The smoothing capacitor Cs smoothes the rectified voltage. Thus, a DC voltage is supplied to the DC-DC converter 13.

The DC-DC converter 13 converts the input DC voltage into a predetermined output DC voltage and outputs the output DC voltage to the charging circuit 14. The charging circuit 14 generates a charging current for the battery BAT from the inputted DC voltage, and charges the battery BAT. That is, the charging circuit 14 charges the battery BAT by the DC power supplied from the DC-DC converter 13 (DC power on the power reception side).

When an electronic load is connected to the Hi-side output terminal POH and the Low-side output terminal POL, the battery BAT executes power supply through the Hi-side output terminal POH and the Low-side output terminal POL. When the power reception device 10 is arranged with respect to the power transmission device 91 and power supply is being performed, the output voltage and the output current of the charging circuit 14 can be outputted to the electronic load through the Hi-side output terminal POH and the Low-side output terminal POL.

The output DC voltage of the DC-DC converter 13 is also supplied to the control circuit 15 and the detection circuit 19.

FIG. 3A is a diagram showing a charging current to the capacitor, and FIG. 3B is a diagram showing a discharging current of the capacitor.

When the power reception device 10 is arranged in a state in which it can receive power with respect to the power transmission device 91, the DC power is supplied to the control circuit 15. The control circuit 15 uses the supplied power to flow a charging current Ich to the capacitor 17 as shown in FIG. 3A. Thus, the capacitor 17 is charged. That is, the capacitor 17 is charged by the capacitor charging circuit during the period when power is received from the power transmission device 91. At this time, a capacitor voltage VCAP of the capacitor 17 (i.e., the voltage between the both ends of the capacitor 17) changes according to the capacitance of the capacitor 17.

On the other hand, when the power reception device 10 is in a state in which it cannot receive power, such as a state in which the power reception device 10 is removed from the power transmission device 91 (i.e., during a period when power is not received from the power transmission device 91), the DC power is not supplied to the control circuit 15. Therefore, as shown in FIG. 3B, the discharging current Idch flows from the capacitor 17 to the resistor 18, so that the capacitor 17 is discharged. At this time, a capacitor voltage VCAP of the capacitor 17 changes according to the storage amount of the capacitor 17. That is, the capacitor voltage VCAP of the capacitor 17 changes according to the charge value (or voltage) accumulated in the capacitor 17 before the capacitor 17 starts discharging after being charged.

The detection circuit 19 stores a threshold voltage VTH for determination. The detection circuit 19 includes, for example, a comparator circuit. The detection circuit 19 compares the capacitor voltage VCAP of the capacitor 17 with the threshold voltage VTH, and outputs a comparison result to the control circuit 15. At this time, for example, the detection circuit 19 includes an AD converter, and performs the comparison in digital values, and outputs the comparison result to the control circuit 15.

The control circuit 15 determines the arrangement state of the power reception device 10 with respect to the power transmission device 91 based on the comparison result.

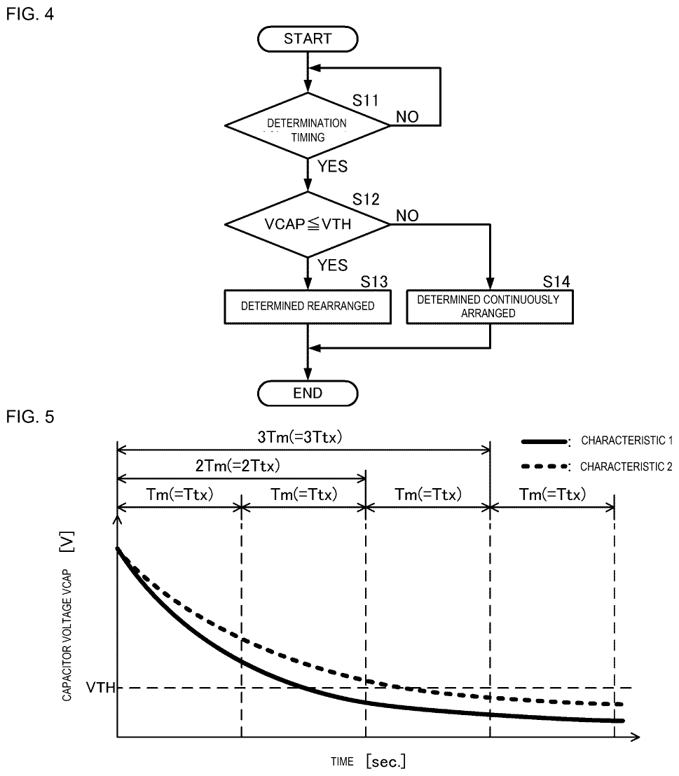

FIG. 4 is a flowchart showing an example of arrangement state determination processing according to the first embodiment.

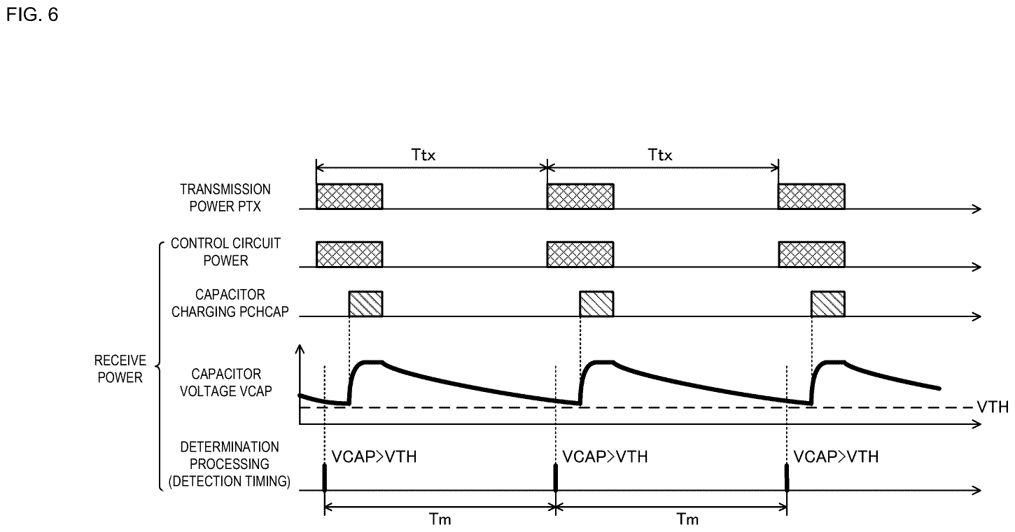

When a preset detection timing is reached (S11: YES), the detection circuit 19 compares the capacitor voltage VCAP and the threshold voltage VTH at this timing, and generates comparison result data. The period TM of the detection timing is set based on the period Ttx of the power transmission control (see FIGS. 5 and 6 to be described later). The detection circuit 19 outputs the comparison result to the control circuit 15.

If the capacitor voltage VCAP is equal to or lower than the threshold voltage VTH on the basis of the comparison result (S12: YES), the control circuit 15 determines that the power reception device 10 is in a state in which it is rearranged with respect to the power transmission device 91 (S13). If the capacitor voltage VCAP is higher than the threshold voltage VTH on the basis of the comparison result (S12: NO), the control circuit 15 determines that the power reception device 10 is in a state in which it is continuously arranged with respect to the power transmission device 91 (S14).

As described above, the control circuit 15 can determine, only by using the charge/discharge control of the capacitor 17 and the capacitor voltage VCAP of the capacitor 17, whether the power reception device 10 is in a state in which it is continuously arranged with respect to the power transmission device 91 or whether the power reception device 10 is in a state in which it is rearranged with respect to the power transmission device 91. That is, the wireless power supply system can distinguish between a state in which the power reception device 10 is still arranged with respect to the power transmission device 91 and a state in which the power reception device 10 has been newly arranged with respect to the power transmission device 91, without executing complicated control.

The determination result in the control circuit 15 is fed back to the power transmission device 91 and used for power transmission control. Specifically, the following processing is performed.

The control circuit 15 generates a notification control signal based on the determination result. The notification control signal is a signal indicating either information indicating the rearrangement state of the power reception device 10 or information indicating the continuous arrangement state of the power reception device 10. The control circuit 15 outputs the notification control signal to the switching elements Q1 and Q2 of the power reception rectification circuit 12.

The switching element Q1 and the switching element Q2 are subjected to a conduction control or an opening control by the notification control signal. Depending on the conduction and opening patterns of the switching element Q1 and the switching element Q2, the impedance seen from the power transmission device 91 (the power transmission resonance circuit 915) to the power reception device 10 (a circuit including the power reception resonance circuit 11 and the power reception rectification circuit 12) changes.

Thus, the state of the electromagnetic field resonance between the power transmission resonance circuit 915 and the power reception resonance circuit 11 changes. Due to such a change, the value of the current flowing through the power transmission resonance circuit 915 changes, and the value of the current flowing from the DC power source 911 to the power transmission switching circuit 914 changes.

The electric variable detection circuit 916 of the power transmission device 91 includes, for example, a resistor inserted into a power line connecting the positive electrode of the DC power source 911 and the power transmission switching circuit 914, and a differential amplifier that generates an electric variable detection signal based on the voltage between the both ends of the resistor.

When the value of the current flowing from the DC power source 911 to the power transmission switching circuit 914 changes, the electric variable detection circuit 916 detects such a change. The electric variable detection circuit 916 generates an electric variable detection signal that corresponds to the detected change in the current amount, and outputs the electric variable detection signal to the MPU 912.

Based on the electric variable detection signal, the MPU 912 acquires whether the power reception device 10 is in a rearrangement state or in a continuous arrangement state. When the power reception device 10 is in a continuous arrangement state, the MPU 912 gives, to the power transmission switching control circuit 913, an instruction to switch from continuous power transmission to intermittent power transmission (i.e., an instruction to stop continuous power transmission and start intermittent power transmission). When the power reception device 10 is in a rearrangement state, the MPU 912 gives, to the power transmission switching control circuit 913, an instruction to switch from intermittent power transmission to continuous power transmission (i.e., an instruction to stop intermittent power transmission and return to continuous power transmission).

Based on the instruction from the MPU 912, the power transmission switching control circuit 913 controls switching of the Hi-side switching element and the Low-side switching element of the power transmission switching circuit 914.

By executing such control, the wireless power supply system, which includes the power transmission device 91 and the power reception device 10, can switch between continuous power transmission and reception (power supply) and intermittent power transmission and reception (power supply) according to the arrangement state of the power reception device 10. Thus, the wireless power supply system can perform necessary power supply while suppressing unnecessary power transmission such as power transmission that occurs when the power reception device 10 is not arranged.

### (Setting of Threshold Voltage VTH)

FIG. 5 is a graph showing the time variation of the capacitor voltage VCAP during discharge. The solid line and broken line in FIG. 5 respectively show different discharge characteristics. In FIG. 5, Tm denotes a period of determination processing, and Ttx denotes a power transmission period that is used as a reference for intermittent power transmission.

When the power reception device 10 is continuously arranged with respect to the power transmission device 91, since power supply is performed in each power transmission period, the capacitor 17 can be both charged and discharged in each power transmission period. On the other hand, when the power reception device 10 is removed from the power transmission device 91, the capacitor 17 is not charged but only discharged in such a power transmission period (when power is not actually transmitted).

By using such a phenomenon, the capacitance of the capacitor 17, the discharging capacity of the capacitor discharging circuit, which is determined by the resistance of the resistor 18 and the like, and the threshold voltage VTH are set so that the capacitor voltage VCAP is higher than the threshold voltage VTH at the timing after one power transmission period, and the capacitor voltage VCAP is equal to or lower than the threshold voltage VTH at the timing after two power transmission periods or longer. That is, the capacitance of the capacitor 17, the threshold voltage VTH, and the discharging capacity of the capacitor discharging circuit are set so that the capacitor voltage VCAP is higher than the threshold voltage VTH even if discharging is continuously performed in a period equal to the period Ttx of the power transmission operation, and the capacitor voltage VCAP becomes equal to or lower than the threshold voltage VTH when discharging is continuously performed in a period at least longer than the period Ttx of the power transmission operation.

As to the time until the capacitor voltage VCAP reaches the threshold voltage VTH, it is preferred that the capacitor voltage VCAP becomes equal to or lower than the threshold voltage VTH at the timing after two power transmission periods. Thus, rearrangement can be determined at a shorter interval.

### (Examples of Timing Chart)

FIG. 6 is a timing chart showing an example of transmission power, control circuit power, capacitor charging power, capacitor voltage, and determination processing in a continuous arrangement state of the power reception device according to the first embodiment.

When the battery BAT is charged, the power transmission device 91 continuously supplies a transmission power PTX to the power reception device 10. The continuous power transmission control is executed on the basis of a trigger of a preset period.

When the power reception device 10 receives the transmission power PTX, the power is supplied to the control circuit 15, so that the control circuit 15 is driven. The control circuit 15 supplies the charging current Ich (capacitor charging power PCHCAP) to the capacitor 17 by using the power supplied to the control circuit 15. Thus, the capacitor 17 is charged, and the capacitor voltage VCAP rises to a fully charged state.

The detection circuit 19 is activated together with the control circuit 15, detects (measures) the capacitor voltage VCAP before the charging current Ich is supplied to the capacitor 17, compares the capacitor voltage VCAP with the threshold voltage VTH, and outputs the comparison result to the control circuit 15. The control circuit 15 determines the arrangement state based on the comparison result.

In a continuous arrangement state, the capacitor 17 is charged in each power transmission period. Therefore, the capacitor voltage VCAP is higher than the threshold voltage VTH at the voltage detection timing (timing used as a reference for determination). Thus, the control circuit 15 can detect that the power reception device 10 is in a continuous arrangement state.

By the method described above, the power reception device 10 notifies the power transmission device 91 that itself is in a continuous arrangement state. The power transmission device 91 detects that the power reception device 10 is in a continuous arrangement state, and continuously executes continuous power transmission control.

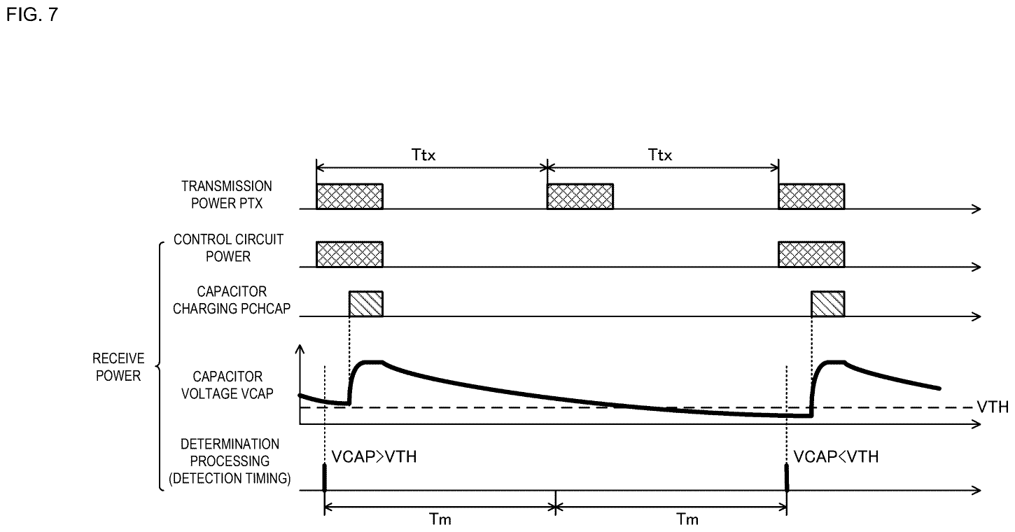

FIG. 7 is a timing chart showing an example of transmission power, control circuit power, capacitor charging power, capacitor voltage, and determination processing in a rearrangement state of the power reception device according to the first embodiment.

For example, when the power reception device 10 is removed from the power transmission device 91 in an intermittent power transmission state, the capacitor 17 of the power reception device 10 is not newly charged, but only discharged continuously. Thus, the capacitor voltage VCAP further decreases to be equal to or lower than the threshold voltage VTH.

From such a state, when the power reception device 10 is rearranged with respect to the power transmission device 91, the control circuit 15 and the detection circuit 19 are restarted, and the detection circuit 19 detects the capacitor voltage VCAP. Here, since the capacitor voltage VCAP is equal to or lower than the threshold voltage VTH, the control circuit 15 detects that the power reception device 10 is in a rearrangement state.

By the method described above, the power reception device 10 notifies the power transmission device 91 that itself is in a rearrangement state. The power transmission device 91 detects that the power reception device 10 is in a rearrangement state, and switches from the intermittent power transmission control to a continuous power transmission control.

By executing such processing and control, the wireless power supply system can more reliably determine whether the power reception device 10 is in a continuous arrangement or in a rearrangement with respect to the power transmission device 91, and can realize power supply control (power transmission control) according to the arrangement state of the power reception device 10 with respect to the power transmission device 91.

### Second Embodiment

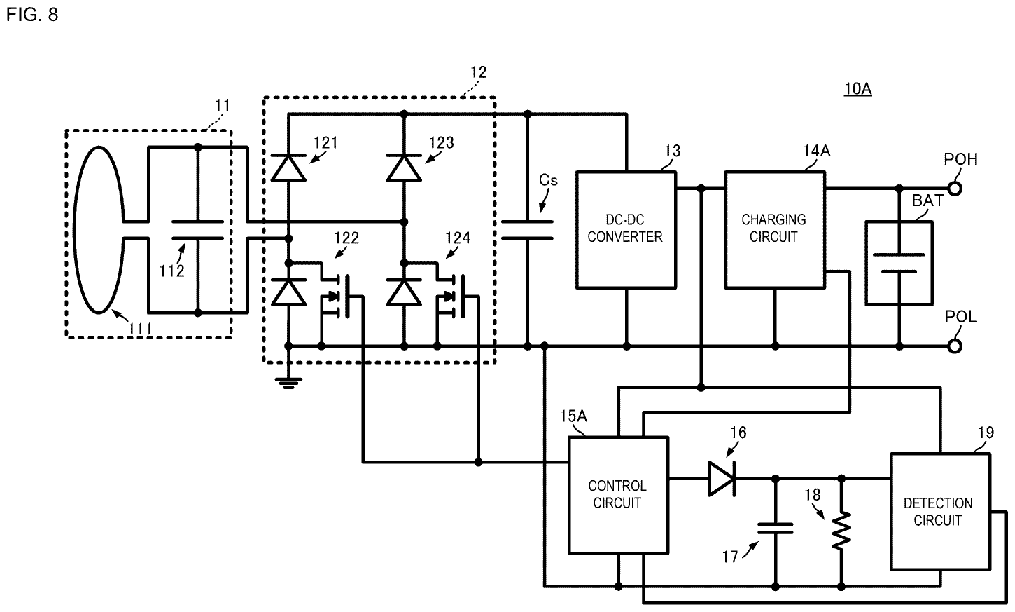

A wireless power supply system according to a second embodiment of the present disclosure will be described with reference to the accompanying drawings. FIG. 8 is a diagram showing an example of a configuration of a power reception device of the wireless power supply system according to the second embodiment of the present disclosure.

As shown in FIG. 8, a power reception device 10A according to the second embodiment is different from the power reception device 10 according to the first embodiment in that it includes a charging circuit 14A and a control circuit 15A, and the control circuit 15A generates a notification control signal by referring to the charging state of the battery BAT. Other configurations of the power reception device 10A are identical or similar to those of the power reception device 10, and descriptions of the identical or similar parts will be omitted.

The charging circuit 14A selects and executes constant current charging or constant voltage charging according to the charging state (SOC) of the battery BAT. Therefore, the charging circuit 14A measures a battery voltage VBAT that corresponds to the charging state of the battery BAT. The charging circuit 14A outputs the battery voltage VBAT to the control circuit 15A.

Based on the charging state of the battery BAT and the determination result of the arrangement of the power reception device 10A, the control circuit 15A generates a notification control signal for determining the start of the power transmission operation for charging the battery BAT or the stop of the power transmission operation.

The control circuit 15A generates the notification control signal based on the comparison result between the capacitor voltage VCAP of the capacitor 17 and the threshold voltage VTH and the comparison result between the battery voltage VBAT and a battery threshold voltage VR.

The notification control signal generated by the control circuit 15A is a signal that indicates any one of: information indicating that the power reception device 10 is in a rearrangement state, information indicating that the power reception device 10 is in a continuous arrangement state and that charging is required, and information indicating that the power reception device 10 is in a continuous arrangement state and that charging is not required.

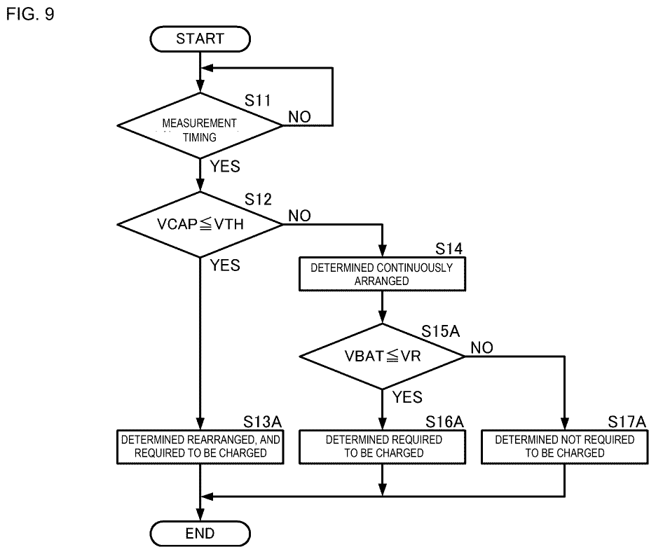

FIG. 9 is a flowchart showing an example of determination processing of the control circuit according to the second embodiment.

The control circuit 15A stores the threshold voltage VTH and the battery threshold voltage VR in advance. When a preset detection timing is reached (S11: YES), the control circuit 15A compares the capacitor voltage VCAP detected by the detection circuit 19 at this timing with the threshold voltage VTH.

If the capacitor voltage VCAP is equal to or lower than the threshold voltage VTH (S12: YES), the control circuit 15A determines that the power reception device 10 is in a state in which it is rearranged with respect to the power transmission device 91 and that charging is required (S13A). If the capacitor voltage VCAP is higher than the threshold voltage VTH (S12: NO), the control circuit 15A determines that the power reception device 10 is in a state in which it is continuously arranged with respect to the power transmission device 91 (S14).

The control circuit 15A compares the battery voltage VBAT with the battery threshold voltage VR. If the battery voltage VBAT is equal to or lower than the battery threshold voltage VR (S15A: YES), the control circuit 15A determines that charging is required even if the power reception device 10 is in a state in which it is continuously arranged with respect to the power transmission device 91 (S16A). If the battery voltage VBAT is higher than the battery threshold voltage VR (S15A: NO), the control circuit 15A determines that the power reception device 10 is in a state in which it is continuously arranged with respect to the power transmission device 91 and that charging is not required (S17A).

As described above, the control circuit 15A can determine, only by using the charge/discharge control of the capacitor 17, the capacitor voltage VCAP of the capacitor 17 and the battery voltage VBAT, whether the power reception device 10A is in a state in which it is continuously arranged with respect to the power transmission device 91, whether the power reception device 10A is in a state in which it is rearranged with respect to the power transmission device 91, and further, whether charging of the battery BAT is required or not required.

The determination result of the control circuit 15A is fed back to the power transmission device 91 to be used for power transmission control. Specifically, the following processing is performed.

The electric variable detection circuit 916 generates an electric variable detection signal that corresponds to a change in the current amount by the above-described notification control signal, and outputs the electric variable detection signal to the MPU 912.

Based on the electric variable detection signal, the MPU 912 acquires information on whether the power reception device 10 is in a rearrangement state or in a continuous arrangement state, and whether charging of the battery BAT is required or not required. If the power reception device 10 is in a continuous arrangement state and charging of the battery BAT is not required, the MPU 912 gives, to the power transmission switching control circuit 913, an instruction to start intermittent power transmission (i.e., an instruction to stop continuous power transmission and start intermittent power transmission).

If the power reception device 10 is in a continuous arrangement state and charging of the battery BAT is required, the MPU 912 gives, to the power transmission switching control circuit 913, an instruction to start continuous power transmission.

If the power reception device 10 is in a rearrangement state, the MPU 912 gives, to the power transmission switching control circuit 913, an instruction to switch from intermittent power transmission to continuous power transmission (i.e., an instruction to stop intermittent power transmission and return to continuous power transmission).

Based on the instruction from the MPU 912, the power transmission switching control circuit 913 controls switching of the Hi-side switching element and the Low-side switching element of the power transmission switching circuit 914.

By executing such control, the wireless power supply system, which includes the power transmission device 91 and the power reception device 10A, can switch between continuous power transmission and reception (power supply) and intermittent power transmission and reception (power supply) in accordance with the arrangement state of the power reception device 10A and the charging state of the battery BAT. Thus, the wireless power supply system can perform necessary power supply while suppressing unnecessary power transmission such as power transmission that occurs when the power reception device 10A is not arranged.

### (Examples of Timing Chart)

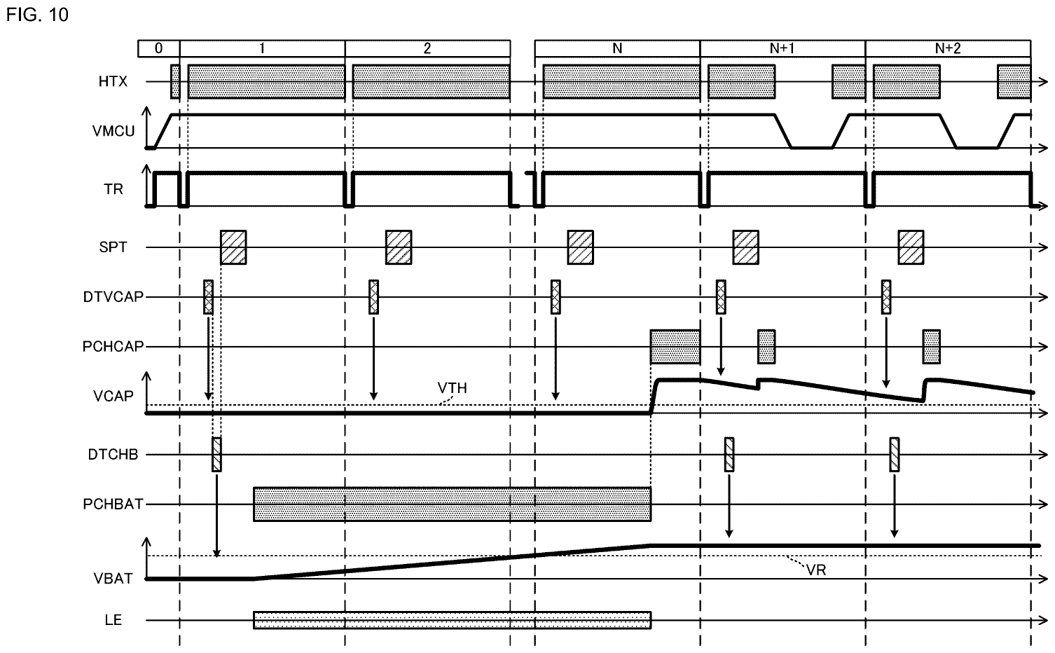

FIG. 10 is a timing chart showing the transition of a period from charging of the battery of the power reception device to intermittent power transmission in a continuous arrangement. FIG. 10 shows an output magnetic field HTX of the power transmission device corresponding to the transmission power, a power supply voltage VMCU of the control circuit 15A, a trigger signal TR, a power communication signal SPT from the power reception device 10A to the power transmission device 91 including the notification control signal, a detection timing DTVCAP of the capacitor voltage VCAP, a charging power PCHCAP of the capacitor 17, the capacitor voltage VCAP of the capacitor 17, a charging detection timing DTCHB of the battery BAT, a charging power PCHBAT of the battery BAT, the battery voltage VBAT of the battery BAT, and a light emission period LE of a charging notification light emitting element.

The power transmission device 91 and the power reception device 10A set a power transmission period and a power reception period in synchronization with the trigger signal TR of a predetermined period, and execute the following control on the basis of the set periods.

As shown by a period 0 to a period N in FIG. 10, when the MPU 912 of the power transmission device 91 is activated, power transmission control for executing continuous power transmission is started. At this time, in the power reception device 10A, the capacitor voltage VCAP of the capacitor 17 is equal to or lower than the threshold voltage VTH, and the battery voltage VBAT is equal to or lower than the battery threshold voltage VR. Therefore, the control circuit 15A generates a notification control signal that indicates a rearrangement (charging required) state. By the power communication signal SPT including the notification control signal, the power reception device 10A informs the power transmission device 91 of the rearrangement (charging required) state. The power transmission device 91 continues continuous power transmission. The power reception device 10A charges the battery BAT by continuous power reception.

When the battery voltage VBAT becomes higher than the battery threshold voltage VR, as indicated by the period N, the control circuit 15A of the power reception device 10A detects that battery voltage VBAT becomes higher than the battery threshold voltage VR, and generates a notification control signal including information that charging is not required. The power reception device 10A charges the capacitor 17 when there is a period (the latter half of the period N in FIG. 10) during which continuous power transmission and reception is continued after the detection of the full charge of the battery BAT.

As indicated by a period N+1, the power transmission device 91 receives a power communication signal that includes the notification control signal indicating that charging is not required, stops continuous power transmission and starts intermittent power transmission.

Since the power reception device 10A is still arranged with respect to the power transmission device 91, the capacitor voltage VCAP is higher than the threshold voltage VTH. Also, the battery voltage VBAT is higher than the battery threshold voltage VR.

Therefore, the control circuit 15A generates a notification control signal that indicates a continuous arrangement state and indicates that charging is not required. By the power communication signal SPT including such a notification control signal, the power reception device 10A informs the power transmission device 91 of the information that indicates the continuous arrangement state and indicates that charging is not required. The power transmission device 91 stops continuous power transmission and starts intermittent power transmission. Further, in such a continuous arrangement state, when detecting a state in which the capacitor voltage VCAP is higher than the threshold voltage VTH, the control circuit 15A charges the capacitor 17 to maintain the state in which the capacitor voltage VCAP is higher than the threshold voltage VTH.

Thereafter, when the power reception device 10A is continuously arranged with respect to the power transmission device 91, as indicated by a period N+2, for example, the information that indicates the continuous arrangement state and indicates that charging is not required is informed from the power reception device 10A to the power transmission device 91 continuously in that period, so that intermittent power transmission is continued.

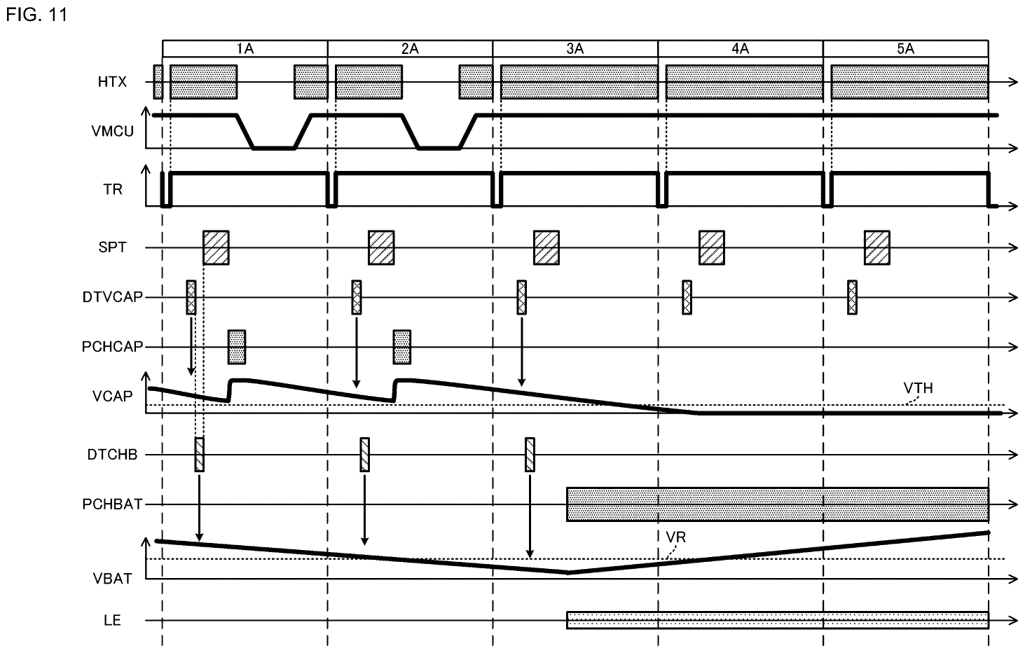

FIG. 11 is a timing chart showing a period from a state in which charging is not performed to a state in which charging is resumed while the power reception device is continuously arranged. FIG. 11 shows the same parameters as those in FIG. 10.

As indicated by a period 1A in FIG. 11, since the power reception device 10A is continuously arranged with respect to the power transmission device 91 and the battery BAT is in a fully charged state before the period 1A, intermittent power transmission is executed, and the charging control of the battery BAT is not executed. Therefore, the battery voltage VBAT gradually decreases. In the period 1A, the capacitor voltage VCAP is higher than the threshold voltage VTH, and the battery voltage VBAT is higher than the battery threshold voltage VR. Therefore, a state in which intermittent power transmission is executed and a state in which the charging control is not executed is continued in the wireless power supply system. Such a state is also continued in a period 2A.

As shown in a period 3A, the discharge of the battery BAT progresses, and the battery voltage VBAT becomes equal to or lower than the battery threshold voltage VR. Therefore, the control circuit 15A generates a notification control signal that indicates a charging required state.

The power reception device 10A informs the power transmission device 91 of the charging required state by the power communication signal SPT including the notification control signal. The power transmission device 91 resumes continuous power transmission. When the power reception device 10A starts receiving power by continuous power transmission from the power transmission device 91, it starts charging the battery BAT by the received power.

At this time, the power reception device 10A does not use the power received from the power transmission device 91 to charge the capacitor 17, but only charge the battery BAT.

The power reception device 10A continues the control for charging only the battery BAT until, for example, the battery BAT becomes fully charged. By performing such control, the power reception device 10A can effectively use the received power to charge the battery BAT.

Note that the battery threshold voltage VR for starting recharging may be the same or different from the battery threshold voltage VR for starting intermittent power transmission (see FIG. 10). When the different voltage values are used, for example, the battery threshold voltage VR for starting recharging (see FIG. 11) may be set lower than the battery threshold voltage VR for starting intermittent power transmission (see FIG. 10), or conversely, may be set higher than the battery threshold voltage VR for starting intermittent power transmission.

### Third Embodiment

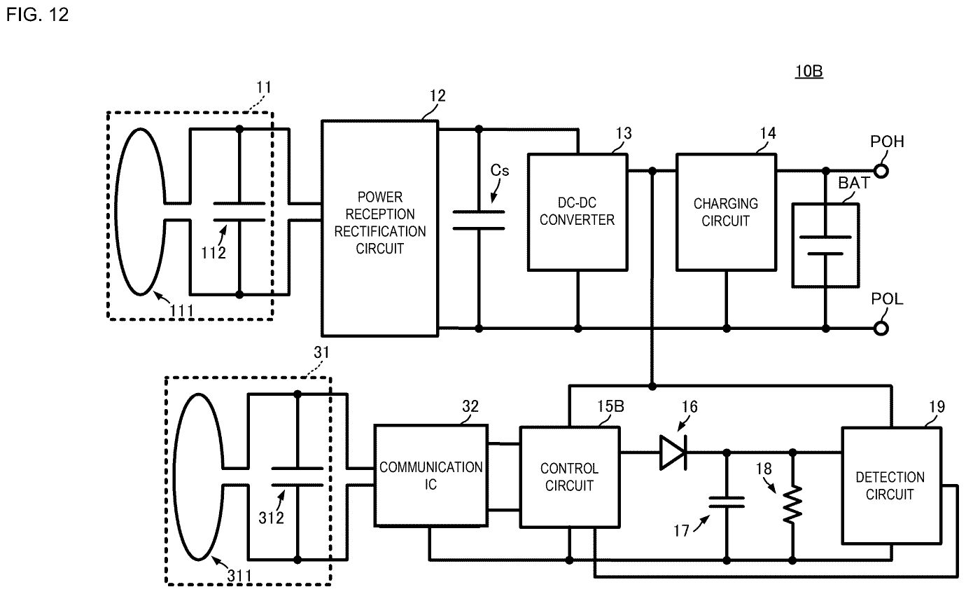

A wireless power supply system according to a third embodiment of the present disclosure will be described with reference to the accompanying drawings. FIG. 12 is a diagram showing an example of a configuration of a power reception device of the wireless power supply system according to the third embodiment of the present disclosure.

As shown in FIG. 12, a power reception device 10B according to the third embodiment is different from the power reception device 10 according to the first embodiment in that it is individually provided with a circuit for charging the battery BAT and a circuit for communicating with the power transmission device 91. Other configurations of the power reception device 10B are identical or similar to those of the power reception device 10, and descriptions of the identical or similar parts will be omitted.

The power reception device 10B includes a power reception resonance circuit 11, a power reception rectification circuit 12, a smoothing capacitor Cs, a DC-DC converter 13, a charging circuit 14, a battery BAT, a control circuit 15B, a diode 16, a capacitor 17, a resistor 18, a detection circuit 19, a communication resonance circuit 31, and a communication IC 32.

The communication resonance circuit 31 includes a communication antenna 311 and a resonance capacitor 312. The communication antenna 311 has the same configuration as that of the power reception coil 111. The resonance capacitor 312 and the communication antenna 311 are connected in parallel. Thus, the communication resonance circuit 31 constitutes a parallel resonance circuit of the communication antenna 311 and the resonance capacitor 312. The resonant frequency of the communication resonance circuit 31 is substantially the same as the frequency of an external alternating magnetic field to which the communication antenna 311 is coupled, or in other words, substantially the same as the switching frequency of the power transmission device 91.

The communication IC 32 is connected to the communication resonance circuit 31, and connected to the control circuit 15B.

The control circuit 15B outputs a notification control signal to the communication IC 32. Based on the notification control signal, the communication IC 32 performs impedance control so that the impedance seen from the power transmission device 91 (the power transmission resonance circuit 915) to the communication resonance circuit 31 of the power reception device 10A changes.

Thus, the power transmission device 91 can identify the arrangement state of the power reception device 10B with respect to the power transmission device 91.

As described above, even if the power reception device 10B is individually provided with a circuit for charging the battery BAT and a circuit for communicating with the power transmission device 91, the same effects as those of the power reception device 10 can be achieved.

### Fourth Embodiment

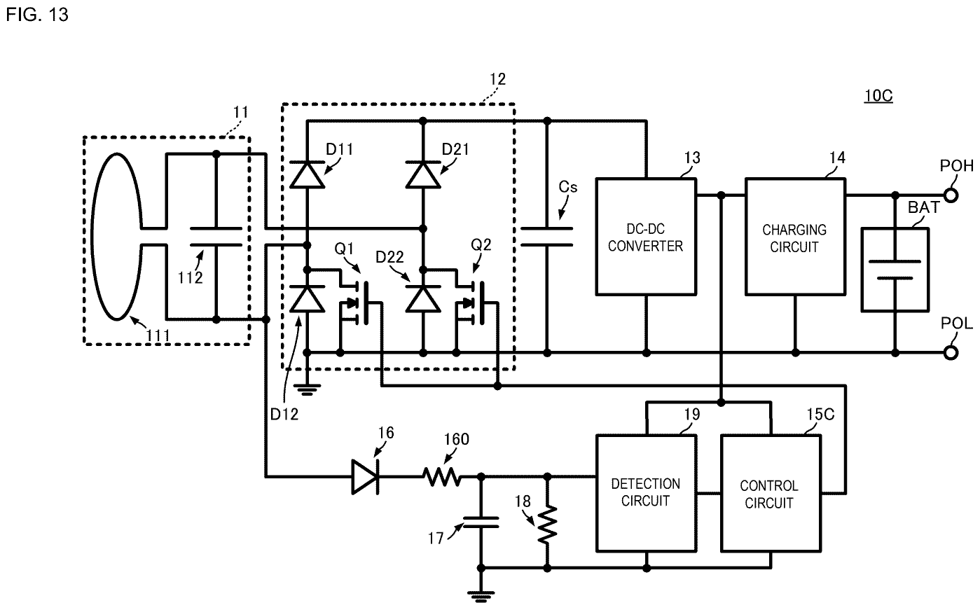

A wireless power supply system according to a fourth embodiment of the present disclosure will be described with reference to the accompanying drawings. FIG. 13 is a diagram showing an example of a configuration of a power reception device of the wireless power supply system according to the fourth embodiment of the present disclosure.

As shown in FIG. 13, a power reception device 10C according to the fourth embodiment is different from the power reception device 10 according to the first embodiment in the mode of charging the capacitor 17 for arrangement determination and the detection timing of the capacitor voltage VCAP. Other configurations of the power reception device 10C are identical or similar to those of the power reception device 10, and descriptions of the identical or similar parts will be omitted.

In general, in the power reception device 10C, the charging power to the capacitor 17 is the output power of the power reception resonance circuit 11. Specifically, the power reception device 10C has the following circuit configuration.

The anode of the diode 16 is connected to one output terminal of the power reception resonance circuit 11 (a terminal to which the node of the diode D11 and the diode D12 of the power reception rectification circuit 12 is connected).

One terminal of a resistor 160 for charge adjustment is connected to the cathode of the diode 16. The other terminal of the resistor 160 is connected to one terminal of the capacitor 17 and one terminal of the resistor 18 for discharge, and is connected to the detection circuit 19. The other terminal of the capacitor 17 and the other terminal of the resistor 18 are connected to the reference potential. The diode 16 and the resistor 160 constitute a capacitor charging circuit.

The capacitor 17 is charged by the output of the power reception resonance circuit 11. At this time, the output of the power reception resonance circuit 11 is an alternating current (high frequency); however, by providing the diode 16, a rectified current flows through the capacitor 17, so that the capacitor 17 can be charged.

Power is supplied to a control circuit 15C and the detection circuit 19 by the output of the DC-DC converter 13.

The detection circuit 19 detects (measures) the capacitor voltage VCAP with a predetermined delay time from the supply start timing of the charging current Ich to the capacitor 17, and outputs the detected capacitor voltage VCAP to the control circuit 15C. The control circuit 15C compares the capacitor voltage VCAP with the threshold voltage VTH, and executes the same processing as that of the control circuit 15.

The power reception device 10C sets the threshold voltage VTH based on the capacitance and the charging capacity with respect to the capacitor 17. Specifically, the capacitance of the capacitor 17, the threshold voltage VTH, the charging capacity of the capacitor charging circuit, the discharging capacity of the capacitor discharging circuit, and the detection timing of the capacitor voltage VCAP are set so that the capacitor voltage VCAP becomes higher than the threshold voltage VTH at the detection timing of the capacitor voltage VCAP when the capacitor 17 is discharged and then charged for a period equivalent to the period Ttx of the power transmission operation. Further, the capacitance of the capacitor 17, the threshold voltage VTH, the charging capacity of the capacitor charging circuit, the discharging capacity of the capacitor discharging circuit, and the detection timing of the capacitor voltage VCAP are set so that the capacitor voltage VCAP becomes equal to or lower than the threshold voltage VTH at the detection timing of the capacitor voltage VCAP when the capacitor 17 is discharged and then charged for a period longer than at least a period equivalent to the period Ttx of the power transmission operation.

### (Examples of Timing Chart)

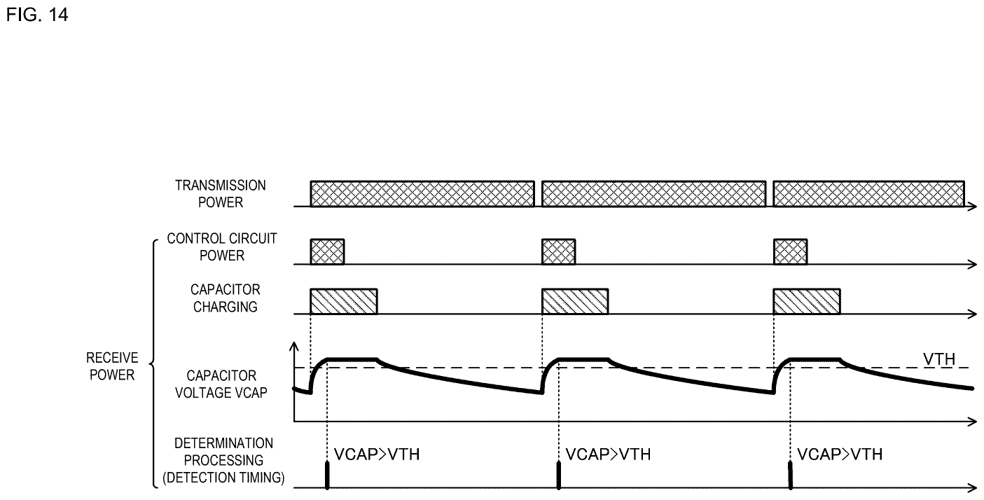

FIG. 14 is a timing chart showing an example of transmission power, control circuit power, capacitor charging power, capacitor voltage, and determination processing in a continuous arrangement state of the power reception device according to the fourth embodiment.

In a continuous arrangement state, the capacitor 17 is charged in each power transmission period. Since the discharge amount of the capacitor 17 in one period is not large, the drop amount of the capacitor voltage VCAP is also small. Therefore, the time for returning to full charged state by charging is short, and the capacitor voltage VCAP increases quickly. Therefore, the capacitor voltage VCAP is higher than the threshold voltage VTH at the detection timing of the capacitor voltage VCAP (the timing used as a reference for determining the arrangement state). As a result, the control circuit 15C can detect that the power reception device 10C is in a continuous arrangement state.

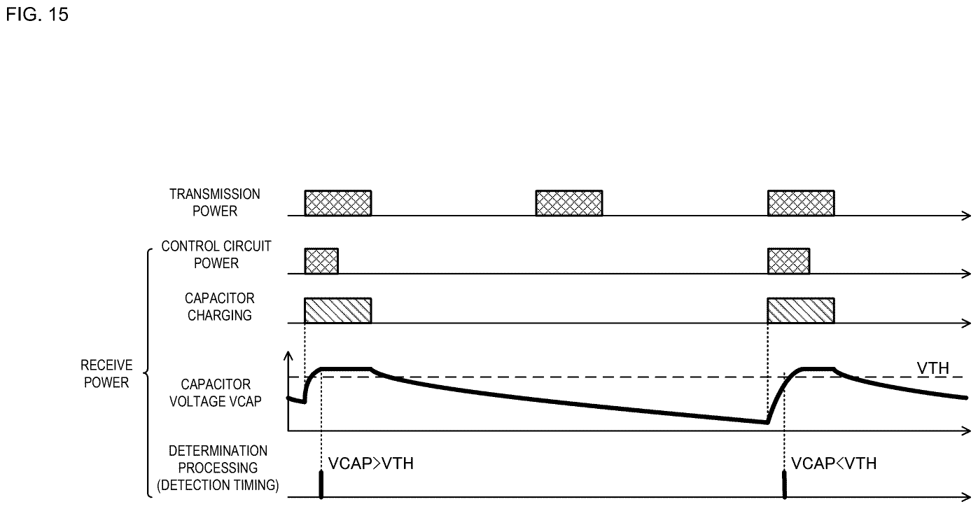

FIG. 15 is a timing chart showing an example of transmission power, control circuit power, capacitor charging power, capacitor voltage, and determination processing in a rearrangement state of the power reception device according to the fourth embodiment.

For example, when the power reception device 10C is removed from the power transmission device 91 in an intermittent power transmission state, the capacitor 17 of the power reception device 10C is not newly charged, but only discharged continuously. As a result, the capacitor voltage VCAP is greatly reduced.

From such a state, when the power reception device 10C is rearranged with respect to the power transmission device 91, the capacitor 17 is charged. However, since the discharging of the capacitor 17 is progressing, it takes time for the capacitor 17 to be fully charged. That is, since the capacitor voltage VCAP at the start of charging is low, the capacitor voltage VCAP is equal to or lower than the threshold voltage VTH at the detection timing of the capacitor voltage VCAP. As a result, the control circuit 15 can detect that the power reception device 10C is in a rearrangement state.

### Fifth Embodiment

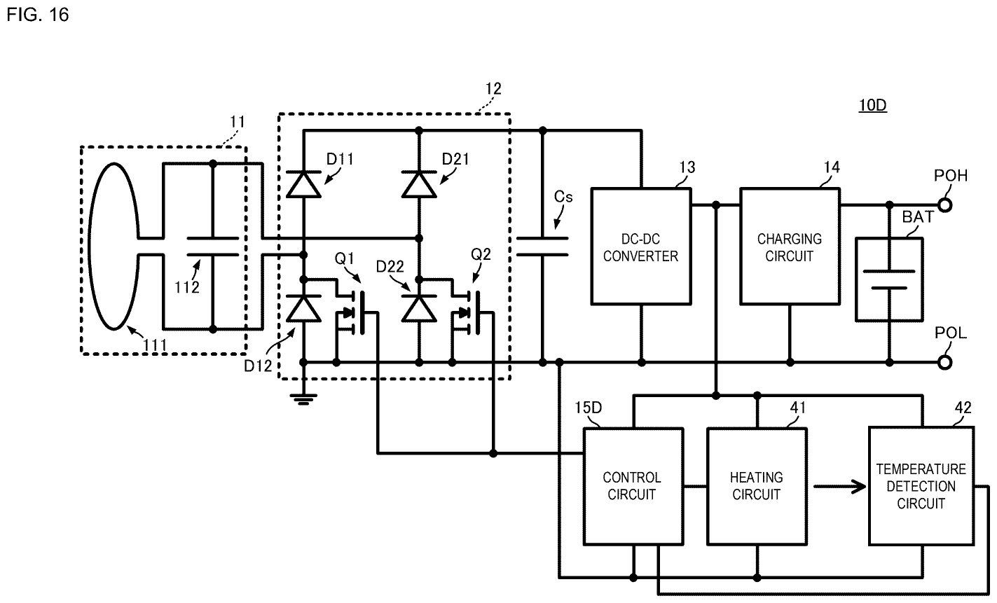

A wireless power supply system according to a fifth embodiment of the present disclosure will be described with reference to the accompanying drawings. FIG. 16 is a diagram showing an example of a configuration of a power reception device of the wireless power supply system according to the fifth embodiment of the present disclosure.

As shown in FIG. 16, a power reception device 10D according to the fifth embodiment is different from the power reception device 10 according to the first embodiment in that it includes a heating circuit 41 and a temperature detection circuit 42, and in the processing of the control circuit 15D. Other configurations of the power reception device 10D are identical or similar to those of the power reception device 10, and descriptions of the identical or similar parts will be omitted.

The power reception device 10D includes the heating circuit 41 and the temperature detection circuit 42.

The heating circuit 41 is connected to the control circuit 15D. The heating circuit 41 is composed of a resistance element and the like. The heating circuit 41 generates heat by energization from the control circuit 15D, and radiates heat when energization is stopped from the control circuit 15D.

The temperature detection circuit 42 detects the temperature of the heating circuit 41, and generates a temperature detection voltage VTMP. The temperature detection circuit 42 is connected to the control circuit 15D, and outputs the temperature detection voltage VTMP to the control circuit 15D.

The control circuit 15D stores a threshold voltage VTHT for arrangement determination. The control circuit 15D compares the temperature detection voltage VTMP with the threshold voltage VTHT.

If the temperature detection voltage VTMP is equal to or lower than the threshold voltage VTHT, the control circuit 15D determines that the power reception device 10D is in a state in which it is rearranged with respect to the power transmission device 91. If the temperature detection voltage VTMP is higher than the threshold voltage VTHT, the control circuit 15D determines that the power reception device 10D is in a state in which it is continuously arranged with respect to the power transmission device 91.

### (Examples of Timing Chart)

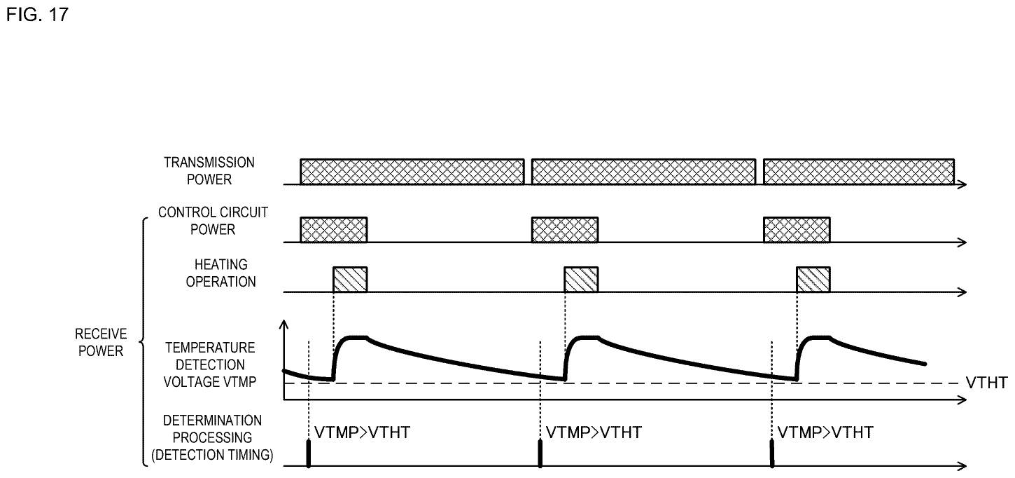

FIG. 17 is a timing chart showing an example of transmission power, control circuit power, heating operation, temperature detection voltage, and determination processing in a continuous arrangement state of the power reception device according to the fifth embodiment.

When the power reception device 10D receives the transmission power PTX, power is supplied to the control circuit 15D, so that the control circuit 15D is driven. The control circuit 15D energizes the heating circuit 41 by using the power supplied to the control circuit 15D. Thus, the heating circuit 41 generates heat, so that the temperature of the heating circuit 41 rises.

The temperature detection circuit 42 is started together with the control circuit 15D, detects (measures) the temperature of the heating circuit 41 before starting energization to the heating circuit 41, and outputs the temperature detection voltage VTMP to the control circuit 15D. The control circuit 15D compares the temperature detection voltage VTMP with the threshold voltage VTHT.

In a continuous arrangement state, the heating circuit 41 is energized in each power transmission period. Therefore, the temperature detection voltage VTMP is higher than the threshold voltage VTHT at a temperature detection timing (timing used as a reference for determination). Thus, the control circuit 15D can detect that the power reception device 10D is in a continuous arrangement state.

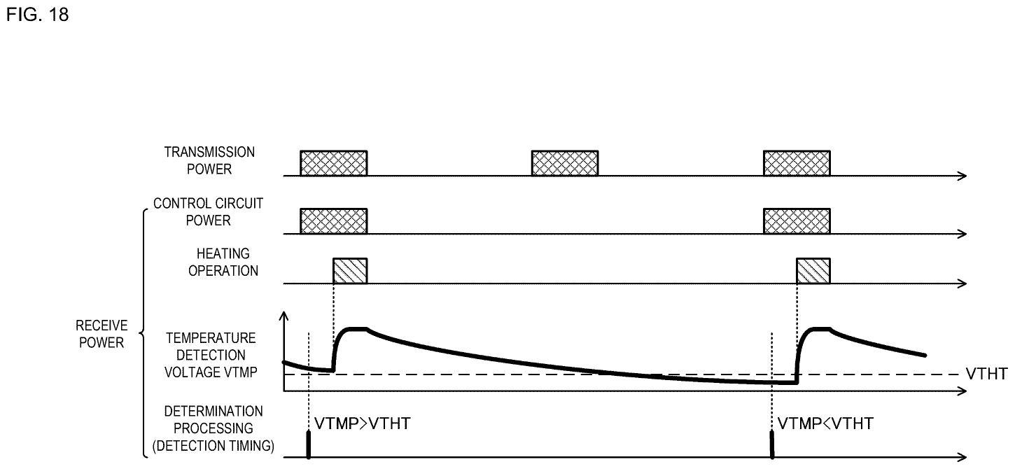

FIG. 18 is a timing chart showing an example of transmission power, control circuit power, heating operation, temperature detection voltage, and determination processing in a rearrangement state of the power reception device according to the fifth embodiment.

For example, when the power reception device 10D is removed from the power transmission device 91 in an intermittent power transmission state, the heating circuit 41 of the power reception device 10D is not newly energized, and only heat radiation is performed continuously. Thus, the temperature detection voltage VTMP further decreases to become equal to or lower than the threshold voltage VTHT.

From such a state, when the power reception device 10D is rearranged with respect to the power transmission device 91, the control circuit 15D and the temperature detection circuit 42 are restarted, and the temperature detection circuit 42 detects the temperature of the heating circuit 41 to generate the temperature detection voltage VTMP. Here, since the temperature detection voltage VTMP is equal to or lower than the threshold voltage VTHT, the control circuit 15D detects that the power reception device 10D is in a rearrangement state.

As described above, the power reception device 10D does not use the amount of electric energy but uses the amount of thermal energy. Even in such a configuration, the power reception device 10D can achieve the same effects as those of the power reception device 10. For example, when the amount of thermal energy is used, a heat storage body that can store heat and radiates heat with the lapse of time may be used, and the amount of heat retained by the heat storage body may be used.

Note that the power reception device may alternatively use other physical energy than electric energy and thermal energy. For example, the power reception device may use the storage of elastic energy in a spring and the lowering of elastic energy with the lapse of time.

### Sixth Embodiment

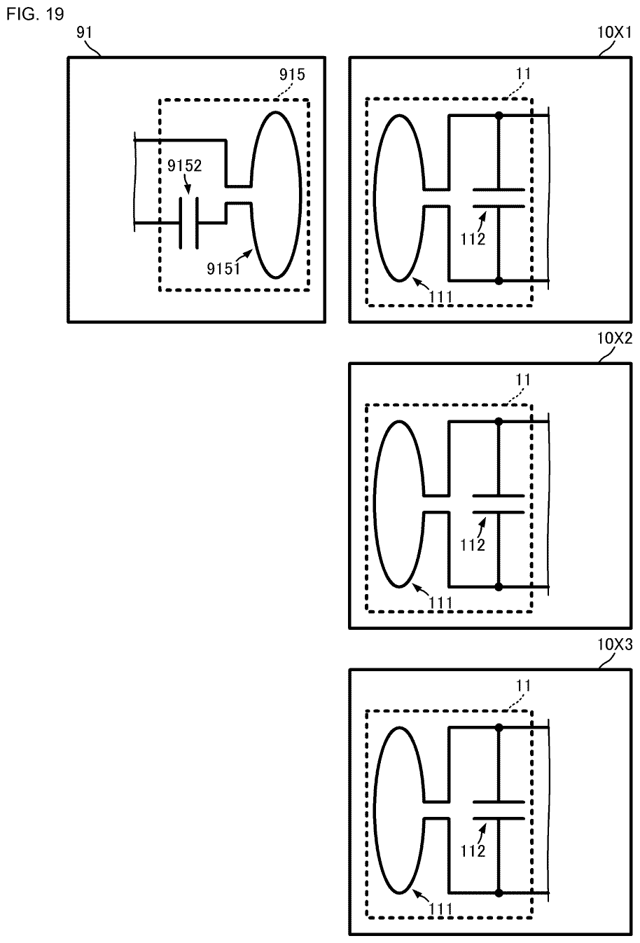

A wireless power supply system according to a sixth embodiment of the present disclosure will be described with reference to the accompanying drawings. FIG. 19 is a diagram partially showing an example of a conceptual configuration of the wireless power supply system according to the sixth embodiment of the present disclosure.

As shown in FIG. 19, the wireless power supply system according to the sixth embodiment is different from the wireless power supply system according to each embodiment described above in that a plurality of power reception devices 10X1, 10X2, and 10X3 are arranged with respect to one power transmission device 91. The number of the power reception devices is three in the present embodiment; however, the number of power reception devices is not limited to three.

Even in the wireless power supply system in which the plurality of power reception devices 10X1, 10X2, and 10X3 are arranged, each of the power reception devices 10X1, 10X2, and 10X3 can determine the arrangement state thereof with respect to the power transmission device 91 by themselves.

For example, when the above-described switching control between continuous power transmission and intermittent power transmission is intended for a plurality of power reception devices in a conventional configuration, a plurality of intermittent power transmissions must be provided. Therefore, the intermittent power transmission period becomes long. In addition, in the conventional configuration, a plurality of power reception devices must detect predetermined intermittent power transmissions, which complicates the control and lowers the reliability of the wireless power supply system. However, in the configuration of the sixth embodiment, there is no need to provide an intermittent power transmission period as in the conventional configuration, which solves the problems of the conventional configuration and improves the reliability of the wireless power supply system.

<1> A wireless power supply system comprising a power transmission device including a power transmission resonance circuit having a power transmission coil; and a power reception device including a power reception resonance circuit having a power reception coil. The power reception device is arranged with respect to the power transmission device for charging, so that the power transmission resonance circuit and the power reception resonance circuit form electromagnetic field resonance coupling to perform wireless power supply. The power transmission device includes a power transmission switching circuit that converts a DC power supplied from a DC power source on a power transmission side into a high-frequency power to be transmitted from the power transmission resonance circuit; and a power transmission switching control circuit that controls the power transmission switching circuit. The power reception device includes a power reception rectification circuit that converts the high-frequency power received by the power reception resonance circuit into a DC power; a battery to be charged by the DC power on a power reception side; a power reception rectification control circuit that controls the power reception rectification circuit; and a power reception state detection circuit that detects an amount of physical energy that changes according to a power reception state. The power transmission device performs an intermittent power transmission operation, and the power reception rectification control circuit determines, based on the amount of physical energy detected by the power reception state detection circuit, whether the power reception device is in a state in which the power reception device is still continuously arranged with respect to the power transmission device or in a state in which the power reception device has been newly rearranged with respect to the power transmission device.

<2> The wireless power supply system according to <1>, wherein the power reception state detection circuit includes a capacitor; a capacitor charging circuit that charges the capacitor; a capacitor discharging circuit that discharges the capacitor; and a capacitor voltage detection circuit that detects a voltage of the capacitor. The capacitor charging circuit performs charging during a period when power is received from the power transmission device. The capacitor discharging circuit performs discharging at least during a period when power is not received from the power transmission device, and the power reception rectification control circuit executes the determination using the voltage of the capacitor.

<3> The wireless power supply system according to <2>, wherein the power reception state detection circuit sets a threshold voltage for determination in advance, and determines, if the voltage of the capacitor is higher than the threshold voltage, that the power reception device is in the continuously arranged state, or determines, if the voltage of the capacitor is equal to or lower than the threshold voltage, that the power reception device is in the rearranged state.

<4> The wireless power supply system according to <3>, wherein a capacitance of the capacitor, the threshold voltage, and a discharging capacity of the capacitor discharging circuit are set such that the voltage of the capacitor is higher than the threshold voltage when the capacitor is charged by the intermittent power transmission operation, and the voltage of the capacitor is equal to or lower than the threshold voltage when the capacitor is continuously discharged in a period at least longer than an interval of adjacent time periods for transmitting power in the intermittent power transmission operation.

<5> The wireless power supply system according to any one of <1> to <4>, wherein the power reception device includes a charging state detection circuit that detects a charging state of the battery, and the power reception rectification control circuit determines, based on the charging state of the battery and a result of determining the state of the arrangement of the power reception device, a start of a power transmission operation for charging the battery, or a stop of the power transmission operation.

<6>

The wireless power supply system according to any one of <1> to <5>, wherein the power reception state detection circuit is connected to an electric circuit different from a charging circuit of the battery, and power supply is controlled by the power reception rectification control circuit without receiving power supply from the battery.

<7> The wireless power supply system according to any one of <1> to <5>, wherein the power reception state detection circuit is connected to an output terminal of the power reception resonance circuit.

<8> The wireless power supply system according to any one of <1> to <7>, wherein the power reception device includes a power reception resonance modulation circuit that changes a resonance condition by varying an input impedance viewed from the power transmission resonance circuit to the power reception resonance circuit. The power transmission device includes an electric variable detection circuit that detects an electric variable supplied from a DC power source on a power transmission side caused by the change of the resonance condition. The power reception rectification control circuit changes the resonance condition of the power reception resonance modulation circuit based on the determination of the rearrangement, and the power transmission switching control circuit demodulates, based on the electric variable detected by the electric variable detection circuit, a start of the power transmission operation and starts a continuous power transmission operation for charging the battery.

<9> The wireless power supply system according to any one of <1> to <8>, wherein the power reception device includes a power reception resonance modulation circuit that changes a resonance condition by varying an input impedance viewed from the power transmission resonance circuit to the power reception resonance circuit. The power transmission device includes an electric variable detection circuit that detects an electric variable supplied from a DC power source on a power transmission side caused by the change of the resonance condition. The power reception rectification control circuit changes the resonance condition of the power reception resonance modulation circuit based on the determination of the continuous arrangement, and the power transmission switching control circuit demodulates, based on the electric variable detected by the electric variable detection circuit, a stop of the power transmission operation and starts the intermittent power transmission operation.

<10> The wireless power supply system according to any one of <1> to <9>, wherein the power reception device includes a plurality of power reception devices, and the plurality of power reception devices form electromagnetic field resonance coupling with the power transmission device that is common to the plurality of power reception devices.

<11> The wireless power supply system according to any one of <1> to <10>, wherein a frequency of a magnetic field of the wireless power supply is in a 6.78 MHz band or a 13.56 MHz band.

<12> A power reception device of a wireless power supply system, the wireless power supply system including a power transmission device including a power transmission resonance circuit having a power transmission coil, and a power reception device including a power reception resonance circuit having a power reception coil. The power reception device is arranged with respect to the power transmission device for charging, whereby the power transmission resonance circuit and the power reception resonance circuit form electromagnetic field resonance coupling to perform wireless power supply. The power reception device comprises a power reception rectification circuit that converts a high-frequency power received by the power reception resonance circuit into a DC power; a battery to be charged by the DC power on a power reception side; a power reception rectification control circuit that controls the power reception rectification circuit; and a power reception state detection circuit that detects an amount of physical energy that changes according to a power reception state. The power reception rectification control circuit determines, based on the amount of physical energy detected by the power reception state detection circuit, whether the power reception device is in a state in which the power reception device is still continuously arranged with respect to the power transmission device or in a state in which the power reception device has been newly rearranged with respect to the power transmission device.

<13> The power reception device according to <12>, wherein the power reception state detection circuit includes a capacitor; a capacitor charging circuit that charges the capacitor; a capacitor discharging circuit that discharges the capacitor; and a capacitor voltage detection circuit that detects a voltage of the capacitor. The capacitor charging circuit performs charging during a period when power is received from the power transmission device. The capacitor discharging circuit performs discharging at least during a period when power is not received from the power transmission device, and the power reception rectification control circuit executes the determination using the voltage of the capacitor.

<14> The power reception device according to <13>, wherein the power reception state detection circuit sets a threshold voltage for determination in advance, and determines, if the voltage of the capacitor is higher than the threshold voltage, that the power reception device is in the continuously arranged state, or determines, if the voltage of the capacitor is equal to or lower than the threshold voltage, that the power reception device is in the rearranged state.

<15> The power reception device according to <14>, wherein a capacitance of the capacitor, the threshold voltage, and a discharging capacity of the capacitor discharging circuit are set such that the voltage of the capacitor is higher than the threshold voltage when the capacitor is charged by an intermittent power transmission operation, and the voltage of the capacitor is equal to or lower than the threshold voltage when the capacitor is continuously discharged in a period at least longer than an interval of adjacent time periods for transmitting power in the intermittent power transmission by the power transmission device.

What is claimed is:

1. A wireless power supply system comprising:
a power transmission device including a power transmission resonance circuit having a power transmission coil; and
a power reception device including a power reception resonance circuit having a power reception coil,
wherein
the power reception device is arranged with respect to the power transmission device for charging, so that the power transmission resonance circuit and the power reception resonance circuit create electromagnetic field resonance coupling to perform wireless power supply,
the power transmission device includes:
a power transmission switching circuit configured to convert a DC power supplied from a DC power source on a power transmission side into a high-frequency power to be transmitted from the power transmission resonance circuit; and
a power transmission switching control circuit configured to control the power transmission switching circuit,
the power reception device includes:
a power reception rectification circuit configured to convert the high-frequency power received by the power reception resonance circuit into a DC power;
a battery to be charged by the DC power on a power reception side;
a power reception rectification control circuit configured to control the power reception rectification circuit; and
a power reception state detection circuit configured to detect an amount of physical energy that changes according to a power reception state,
the power transmission device is configured to perform an intermittent power transmission operation, and
the power reception rectification control circuit is configured to determine, based on the amount of physical energy detected by the power reception state detection circuit, whether the power reception device is in a state in which the power reception device is still continuously arranged with respect to the power transmission device or in a state in which the power reception device has been newly rearranged with respect to the power transmission device.

2. The wireless power supply system according to claim 1, wherein
the power reception state detection circuit includes:
a capacitor;
a capacitor charging circuit configured to charge the capacitor;
a capacitor discharging circuit configured to discharge the capacitor; and
a capacitor voltage detection circuit configured to detect a voltage of the capacitor,
the capacitor charging circuit is configured to perform charging during a period when power is received from the power transmission device,
the capacitor discharging circuit is configured to perform discharging at least during a period when power is not received from the power transmission device, and
the power reception rectification control circuit is configured to execute the determination using the voltage of the capacitor.

3. The wireless power supply system according to claim 2, wherein
the power reception state detection circuit is configured to set a threshold voltage for determination in advance, and determine, if the voltage of the capacitor is higher than the threshold voltage, that the power reception device is in the continuously arranged state, or determine, if the voltage of the capacitor is equal to or lower than the threshold voltage, that the power reception device is in the rearranged state.

4. The wireless power supply system according to claim 3, wherein
a capacitance of the capacitor, the threshold voltage, and a discharging capacity of the capacitor discharging circuit are set such that the voltage of the capacitor is higher than the threshold voltage when the capacitor is charged by the intermittent power transmission operation, and the voltage of the capacitor is equal to or lower than the threshold voltage when the capacitor is continuously discharged in a period at least longer than an interval of adjacent time periods for transmitting power in the intermittent power transmission operation.

5. The wireless power supply system according to claim 1, wherein
the power reception device includes:
a charging state detection circuit configured to detect a charging state of the battery, and
the power reception rectification control circuit is configured to determine, based on the charging state of the battery and a result of determining the state of the arrangement of the power reception device, a start of a power transmission operation for charging the battery, or a stop of the power transmission operation.

6. The wireless power supply system according to claim 1, wherein
the power reception state detection circuit is connected to an electric circuit different from a charging circuit of the battery, and power supply is controlled by the power reception rectification control circuit without receiving power supply from the battery.

7. The wireless power supply system according to claim 1, wherein
the power reception state detection circuit is connected to an output terminal of the power reception resonance circuit.

8. The wireless power supply system according to claim 1, wherein
the power reception device includes a power reception resonance modulation circuit configured to change a resonance condition by varying an input impedance viewed from the power transmission resonance circuit to the power reception resonance circuit,
the power transmission device includes an electric variable detection circuit configured to detect an electric variable supplied from a DC power source on a power transmission side caused by the change of the resonance condition,
the power reception rectification control circuit is configured to change the resonance condition of the power reception resonance modulation circuit based on the determination of the rearrangement, and
the power transmission switching control circuit is configured to demodulate, based on the electric variable detected by the electric variable detection circuit, a start of the power transmission operation and starts a continuous power transmission operation for charging the battery.

9. The wireless power supply system according to claim 1, wherein
the power reception device includes a power reception resonance modulation circuit configured to change a resonance condition by varying an input impedance viewed from the power transmission resonance circuit to the power reception resonance circuit,
the power transmission device includes an electric variable detection circuit configured to detect an electric variable supplied from a DC power source on a power transmission side caused by the change of the resonance condition,
the power reception rectification control circuit is configured to change the resonance condition of the power reception resonance modulation circuit based on the determination of the continuous arrangement, and
the power transmission switching control circuit is configured to demodulate, based on the electric variable detected by the electric variable detection circuit, a stop of the power transmission operation and start the intermittent power transmission operation.

10. The wireless power supply system according to claim 1, wherein
the power reception device includes a plurality of power reception devices, and
the plurality of power reception devices are configured to create electromagnetic field resonance coupling with the power transmission device that is common to the plurality of power reception devices.

11. The wireless power supply system according to claim 1, wherein
a frequency of a magnetic field of the wireless power supply is in a 6.78 MHz band or a 13.56 MHz band.

12. The wireless power supply system according to claim 2, wherein
the power reception device includes:
a charging state detection circuit configured to detect a charging state of the battery, and
the power reception rectification control circuit is configured to determine, based on the charging state of the battery and a result of determining the state of the arrangement of the power reception device, a start of a power transmission operation for charging the battery, or a stop of the power transmission operation.

13. The wireless power supply system according to claim 2, wherein
the power reception state detection circuit is connected to an electric circuit different from a charging circuit of the battery, and power supply is controlled by the power reception rectification control circuit without receiving power supply from the battery.

14. The wireless power supply system according to claim 2, wherein
the power reception state detection circuit is connected to an output terminal of the power reception resonance circuit.

15. The wireless power supply system according to claim 2, wherein
the power reception device includes a power reception resonance modulation circuit configured to change a resonance condition by varying an input impedance viewed from the power transmission resonance circuit to the power reception resonance circuit,
the power transmission device includes an electric variable detection circuit configured to detect an electric variable supplied from a DC power source on a power transmission side caused by the change of the resonance condition,
the power reception rectification control circuit is configured to change the resonance condition of the power reception resonance modulation circuit based on the determination of the rearrangement, and
the power transmission switching control circuit is configured to demodulate, based on the electric variable detected by the electric variable detection circuit, a start of the power transmission operation and starts a continuous power transmission operation for charging the battery.

16. The wireless power supply system according to claim 2, wherein
the power reception device includes a power reception resonance modulation circuit configured to change a resonance condition by varying an input impedance viewed from the power transmission resonance circuit to the power reception resonance circuit,
the power transmission device includes an electric variable detection circuit configured to detect an electric variable supplied from a DC power source on a power transmission side caused by the change of the resonance condition,
the power reception rectification control circuit is configured to change the resonance condition of the power reception resonance modulation circuit based on the determination of the continuous arrangement, and
the power transmission switching control circuit is configured to demodulate, based on the electric variable detected by the electric variable detection circuit, a stop of the power transmission operation and start the intermittent power transmission operation.

17. A power reception device of a wireless power supply system, the wireless power supply system including a power transmission device including a power transmission resonance circuit having a power transmission coil, and a power reception device including a power reception resonance circuit having a power reception coil, the power reception device being arranged with respect to the power transmission device for charging, whereby the power transmission resonance circuit and the power reception resonance circuit create electromagnetic field resonance coupling to perform wireless power supply, the power reception device comprising:
a power reception rectification circuit configured to convert a high-frequency power received by the power reception resonance circuit into a DC power;
a battery to be charged by the DC power on a power reception side;
a power reception rectification control circuit configured to control the power reception rectification circuit; and
a power reception state detection circuit configured to detect an amount of physical energy that changes according to a power reception state,
wherein
the power reception rectification control circuit is configured to determine, based on the amount of physical energy detected by the power reception state detection circuit, whether the power reception device is in a state in which the power reception device is still continuously arranged with respect to the power transmission device or in a state in which the power reception device has been newly rearranged with respect to the power transmission device.

18. The power reception device according to claim 17, wherein
the power reception state detection circuit includes:
a capacitor;
a capacitor charging circuit configured to charge the capacitor;
a capacitor discharging circuit configured to discharge the capacitor; and
a capacitor voltage detection circuit configured to detect a voltage of the capacitor,
the capacitor charging circuit is configured to perform charging during a period when power is received from the power transmission device,
the capacitor discharging circuit is configured to perform discharging at least during a period when power is not received from the power transmission device, and
the power reception rectification control circuit is configured to execute the determination using the voltage of the capacitor.

19. The power reception device according to claim 18, wherein
the power reception state detection circuit is configured to set a threshold voltage for determination in advance, and determine, if the voltage of the capacitor is higher than the threshold voltage, that the power reception device is in the continuously arranged state, or determines, if the voltage of the capacitor is equal to or lower than the threshold voltage, that the power reception device is in the rearranged state.

20. The power reception device according to claim 19, wherein
a capacitance of the capacitor, the threshold voltage, and a discharging capacity of the capacitor discharging circuit are set such that the voltage of the capacitor is higher than the threshold voltage when the capacitor is charged by an intermittent power transmission operation, and the voltage of the capacitor is equal to or lower than the threshold voltage when the capacitor is continuously discharged in a period at least longer than an interval of adjacent time periods for transmitting power in the intermittent power transmission by the power transmission device.
